(19) United States
(12) Patent Application Publication
(10) Pub. No.: US 2022/0111259 A1
(43) Pub. Date: Apr. 14, 2022

(54) GOLF BALL

(71) Applicant: Bridgestone Sports Co., Ltd., Tokyo (JP)

(72) Inventors: Masahiro YAMABE, Chichibushi (JP); Katsunobu MOCHIZUKI, Chichibushi (JP)

(73) Assignee: Bridgestone Sports Co., Ltd., Tokyo (JP)

(21) Appl. No.: 17/557,499

(22) Filed: Dec. 21, 2021

Related U.S. Application Data
(63) Continuation-in-part of application No. 16/896,459, filed on Jun. 9, 2020.

(30) Foreign Application Priority Data
Jun. 27, 2019 (JP) 2019-119575

(51) Int. Cl. A63B 37/00; C08L 9/00; C08L 75/08

(52) U.S. Cl. CPC A63B 37/0024; A63B 37/0031; A63B 37/0096; A63B 37/0095; C08L 9/00; C08L 2207/04; A63B 37/0075; C08L 2205/03; C08L 2205/035; C08L 2207/53; C08L 75/08

(57) ABSTRACT

In a golf ball having a core of at least one layer and a cover of one or more layer encasing the core, at least one layer of the cover is formed of a resin composition that includes (I) a polyurethane or a polyurea and (II) an aromatic vinyl elastomer which together satisfy certain specific conditions. The golf ball has an excellent controllability on approach shots and is also able to maintain a good scuff resistance.

### CROSS-REFERENCE TO RELATED APPLICATION

This application is a continuation-in-part of copending application Ser. No. 16/896,459 filed on Jun. 9, 2020, claims priority under 35 U.S.C. § 119(a) on Patent Application No. 2019-119575 filed in Japan on Jun. 27, 2019, the entire contents of which are hereby incorporated by reference.

### TECHNICAL FIELD

The present invention relates to a multilayer golf ball of two or more pieces having a is core and a cover. More particularly, the invention relates to a golf ball that is endowed with an excellent spin performance on approach shots and has also an excellent scuff resistance.

### BACKGROUND ART

The property most desired in a golf ball is an increased distance, but other desirable properties include the ability for the ball to stop well on approach shots and a good scuff resistance. Many golf balls have hitherto been developed that exhibit a good flight performance on shots with a driver and are suitably receptive to backspin on approach shots. Also, materials endowed with a high rebound and a good scuff resistance have been developed as golf ball cover materials.

Urethane resin materials are often used in place of ionomer resin materials as such cover materials, particularly in golf balls for professional golfers and skilled amateurs. However, professional golfers and skilled amateurs desire golf balls having even better controllability on approach shots. Specifically, they want excellent maneuverability and more delicate control around the green with short irons such as a sand wedge (SW). To this end, further improvements are being sought in cover materials made using a urethane resin as the base resin.

A number of polymer blend-type cover materials obtained by using a urethane resin as the base resin and mixing other resins therein have been described in the art. For example, to improve the scuff resistance of a cover material, JP-A H11-9721 discloses the use of a blend composed of a thermoplastic polyurethane and a styrene-based block copolymer as the base resin of the cover. However, covers made of this blend are inadequate in terms of their resilience and scuff resistance.

The properties of thermoplastic urethane elastomers have recently been upgraded, one such improved property being the scuff resistance. Hence, when blending another resin material into such a thermoplastic urethane elastomer, it is desired that a decrease in the scuff resistance inherent to the thermoplastic urethane elastomer be avoided through judicious adjustments in the type and content of the blended resin.

In addition, it is also desired that, when blending a urethane resin material with another resin material for the purpose of lowering the hardness, changes in the resilience and a worsening of the moldability be avoided to the extent possible.

### SUMMARY OF THE INVENTION

It is therefore an object of the present invention to provide a golf ball which has an excellent controllability on approach shots without lowering the distance traveled by the ball on shots with a driver, and which moreover can maintain a good scuff resistance.

As a result of extensive investigations, we have discovered that, in a golf ball having a core and a cover, by using as the cover material a resin composition which, to further improve a resin material that uses a polyurethane or a polyurea as the chief ingredient, includes an aromatic vinyl elastomer together with the polyurethane or polyurea, and by producing a golf ball wherein, letting HMA (N/mm²) be the Martens hardness of the polyurethane or polyurea, HMb (N/mm²) be the Martens hardness of the cover layer formed of the resin composition containing the polyurethane or polyurea and an aromatic vinyl elastomer. HMa and HMb satisfy formula (1) below

0.990≤HMa/HMb≤≡1.500 (1)

and by setting a material hardness of the component (II) within 10 to 40 on the Shore D hardness scale, the golf ball has a low initial velocity yet a high spin rate and thus excellent controllability on approach shots, and moreover is able to maintain a good scuff resistance.

That is, when the outermost layer of the cover is formed of a resin composition that uses a polyurethane or a polyurea as the chief ingredient, the softer the polyurethane or other resin that is used, the better the spin performance of the ball on approach shots, although such a ball tends to have a high initial velocity and to be difficult to control on approach shots. However, it is known that by adding an aromatic vinyl elastomer in any amount, the initial velocity/controllability can be improved (meaning that the initial velocity can be held down and a good controllability on approach shots maintained) while maintaining the spin rate and scuff resistance. The Martens hardness of such a low-resilience cover layer were thus specified as indicated above for the golf ball.

Accordingly, the present invention provides a golf ball comprising a core of at least one layer and a cover of one or more layer encasing the core, wherein at least one layer of the cover is formed of a resin composition comprising:

(I) a polyurethane or a polyurea, and

(II) an aromatic vinyl elastomer, and

letting HMa (N/mm²) be the Martens hardness of the resin material of component (I), HMb (N/mm²) be the Martens hardness of the cover layer formed of the resin composition containing components (I) and (II), HMa and HMb satisfy formula (1) below

0.990≤HMa/HMb≤1.500 (1)

and wherein the component (II) has a material hardness of from 10 to 40 on the Shore D hardness scale.

In a preferred embodiment of the golf ball of the invention, letting ηItb (%) be the elastic work recovery of the cover layer, the golf ball satisfies formula (2) below

2.00≤ηItb/HMb≤7.00 (2).

In another preferred embodiment of the inventive golf ball, letting ηIta (%) be the elastic work recovery of the resin material of component (I), the golf ball satisfies formula (3) below:

0.980≤ηIta/ηItb≤1.050 (3).

In yet another preferred embodiment, the golf ball satisfies formula (4) below

0.800≤(ηIta·HMb)/(ηItb·HMa)≤1.050 (4).

In still another preferred embodiment, the content of component (II) is 25 parts by weight or less per 100 parts by weight of component (1).

In a further preferred embodiment, the rebound resilience of component (II), as measured according to JIS-K 6255 is from 10 to 35%.

In a yet further preferred embodiment, the aromatic vinyl compound content in the component (II) is from 45 to 70 wt %.

In an additional preferred embodiment, the resin composition of the cover comprises a thermoplastic polyester elastomer serving as component (III) where the content of component (III) is 30 wt % or less of the resin composition.

In the case, it is preferable that component (III) has a material hardness of from 20 to 50 on the Shore D hardness scale.

Also, it is preferable that the rebound resilience of component (III), as measured according to JIS-K 6255 is from 50 to 80%.

Furthermore, it is preferable that component (Ill) has a melt viscosity at 200° C. and a shear rate of 243 sec⁻¹ which is from 0.3×10⁴ to 1.5×10⁴ dPa·s.

### Advantageous Effects of the Invention

The golf ball of the invention has an excellent controllability on approach shots and is also able to maintain a good scuff resistance.

### BRIEF DESCRIPTION OF THE DIAGRAM

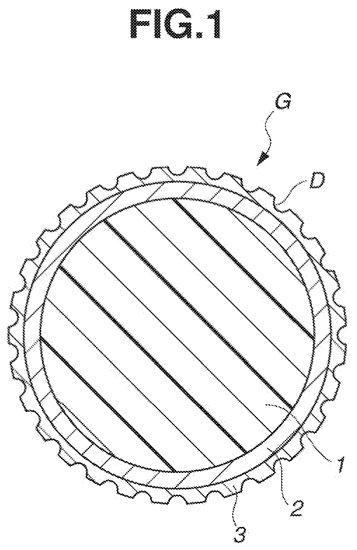

FIG. 1 is a schematic cross-sectional view of a golf ball according to one embodiment of the invention.

### DESCRIPTION OF THE PREFERRED EMBODIMENTS

The objects, features and advantages of the invention will become more apparent from the following detailed description taken in conjunction with the appended diagram.

The golf ball of the invention has a core of at least one layer and a cover of one or more layer encasing the core. For example, referring to FIG. 1, the ball may be a multi-piece solid golf ball G having a core 1, an intermediate layer (inside cover layer) 2 encasing the core 1, and an outermost layer (outside cover layer) 3 encasing the intermediate layer 2. The outside cover layer 3 is positioned as the outermost layer, aside from a coating layer, in the layer construction of the golf ball. Numerous dimples are generally formed on the surface of the outside cover layer (outermost layer) 3 in order to enhance the aerodynamic properties. Although not shown in the attached diagram, a coating layer is typically formed on the surface of the outside cover layer 3.

The core may be formed using a known rubber material as the base material. A known base rubber such as a natural rubber or a synthetic rubber may be used as the base rubber. More specifically, it is recommended that polybutadiene, especially cis-1,4-polybutadiene having a cis structure content of at least 40%, be chiefly used. If desired, natural rubber, polyisoprene rubber, styrene-butadiene rubber or the like may be used together with the foregoing polybutadiene in the base rubber.

The polybutadiene may be synthesized with a metal catalyst, such as a neodymium or other rare-earth catalyst, a cobalt catalyst or a nickel catalyst.

Co-crosslinking agents such as unsaturated carboxylic acids and metal salts thereof, inorganic fillers such as zinc oxide, barium sulfate and calcium carbonate, and organic peroxides such as dicumyl peroxide and 1,1-bis(t-butylperoxy)cyclohexane may be included in the base rubber. If necessary, commercial antioxidants and the like may be suitably added.

The core may be produced by vulcanizing/curing the rubber composition containing the above ingredients. For example, production may be carried out by kneading the composition using a mixer such as a Banbury mixer or a roll mill, compression molding or injection molding the kneaded composition using a mold, and curing the molded body by suitably heating it at a temperature sufficient for the organic peroxide and the co-crosslinking agent to act, i.e., from about 100° C. to about 200° C., and preferably from 140 to 180° C., for a period of 10 to 40 minutes.

In this invention, at least one layer of the cover is formed with a resin composition containing components (I) and (II) below:

(I) a polyurethane or a polyurea

(II) an aromatic vinyl elastomer.

Components (I) and (II) are described in detail below.

### (I) Polyurethane or Polyurea

The polyurethane or polyurea is a substance that is capable of serving as the base resin of the above cover material (resin composition). The polyurethane (I-a) or polyurea (I-b) serving as this component is described in detail below.

### (I-a) Polyurethane

The polyurethane has a structure which includes soft segments composed of a polymeric polyol (polymeric glycol) that is a long-chain polyol, and hard segments composed of a chain extender and a polyisocyanate. Here, the polymeric polyol serving as a starting material may be any that has hitherto been used in the art relating to polyurethane materials, and is not particularly limited. It is exemplified by polyester polyols, polyether polyols, polycarbonate polyols, polyester polycarbonate polyols, polyolefin polyols, conjugated diene polymer-based polyols, castor oil-based polyols, silicone-based polyols and vinyl polymer-based polyols. Specific examples of polyester polyols that may be used include adipate-type polyols such as polyethylene adipate glycol, polypropylene adipate glycol, polybutadiene adipate glycol and polyhexamethylene adipate glycol; and lactone-type polyols such as polycaprolactone polyol. Examples of polyether polyols include poly(ethylene glycol), poly(propylene glycol), poly(tetramethylene glycol) and poly(methyltetramethylene glycol). These polyols may be used singly, or two or more may be used in combination.

It is preferable to use a polyether polyol as the above polymeric polyol.

The long-chain polyol has a number-average molecular weight that is preferably in the range of 1,000 to 5,000. By using a long-chain polyol having a number-average molecular weight in this range, golf balls made with a polyurethane composition that have excellent properties, including a good rebound and good productivity, can be reliably obtained. The number-average molecular weight of the long-chain polyol is more preferably in the range of 1,500 to 4,000, and even more preferably in the range of 1,700 to 3,500.

Here and below, “number-average molecular weight” refers to the number-average molecular weight calculated based on the hydroxyl value measured in accordance with JIS-K1557.

The chain extender is not particularly limited; any chain extender that has hitherto been employed in the art relating to polyurethanes may be suitably used. In this invention, low-molecular-weight compounds with a molecular weight of 2,000 or less which have on the molecule two or more active hydrogen atoms capable of reacting with isocyanate groups may be used. Of these, preferred use can be made of aliphatic diols having from 2 to 12 carbon atoms. Specific examples include 1,4-butylene glycol, 1,2-ethylene glycol, 1,3-butanediol, 1,6-hexanediol and 2,2-dimethyl-1,3-propanediol. Of these, the use of 1,4-butylene glycol is especially preferred.

Any polyisocyanate hitherto employed in the art relating to polyurethanes may be suitably used without particular limitation as the polyisocyanate. For example, use can be made of one or more selected from the group consisting of 4,4′-diphenylmethane diisocyanate, 2,4-toluene diisocyanate, 2,6-toluene diisocyanate, p-phenylene diisocyanate, xylylene diisocyanate, 1,5-naphthylene diisocyanate, tetramethylxylene diisocyanate, hydrogenated xylylene diisocyanate, dicyclohexylmethane diisocyanate, tetramethylene diisocyanate, hexamethylene diisocyanate, isophorone diisocyanate, norbornene diisocyanate, trimethylhexamethylene diisocyanate, 1,4-bis(isocyanatomethyl)cyclohexane and dimer acid diisocyanate. However, depending on the type of isocyanate, crosslinking reactions during injection molding may be difficult to control.

The ratio of active hydrogen atoms to isocyanate groups in the polyurethane-forming reaction may be suitably adjusted within a preferred range. Specifically, in preparing a polyurethane by reacting the above long-chain polyol, polyisocyanate and chain extender, it is preferable to use the respective components in proportions such that the amount of isocyanate groups included in the polyisocyanate per mole of active hydrogen atoms on the long-chain polyol and the chain extender is from 0.95 to 1.05 moles.

The method for preparing the polyurethane is not particularly limited. Preparation using the long-chain polyol, chain extender and polyisocyanate may be carried out by either a prepolymer process or a one-shot process via a known urethane-forming reaction. Of these, melt polymerization in the substantial absence of solvent is preferred. Production by continuous melt polymerization using a multiple screw extruder is especially preferred.

It is preferable to use a thermoplastic polyurethane material as the polyurethane, with an ether-based thermoplastic polyurethane material being especially preferred. The thermoplastic polyurethane material used may be a commercial product, illustrative examples of which include those available under the trade name PANDEX from DIC Covestro Polymer, Ltd., and those available under the trade name RESAMINE from Dainichiseika Color & Chemicals Mfg. Co., Ltd.

### (I-b) Polyurea

The polyurea is a resin composition composed primarily of urea linkages formed by reacting (i) an isocyanate with (ii) an amine-terminated compound. This resin composition is described in detail below.

### (i) Isocyanate

The isocyanate is not particularly limited. Any isocyanate used in the prior art relating to polyurethanes may be suitably used here. Use may be made of isocyanates similar to those mentioned above in connection with the polyurethane material.

### (ii) Amine-Terminated Compound

An amine-terminated compound is a compound having an amino group at the end of the molecular chain. In this invention, the long-chain polyamines and/or amine curing agents shown below may be used.

A long-chain polyamine is an amine compound which has on the molecule at least two amino groups capable of reacting with isocyanate groups, and which has a number-average molecular weight of from 1,000 to 5,000. In this invention, the number-average molecular weight is more preferably from 1,500 to 4,000, and even more preferably from 1.900 to 3,000. Examples of such long-chain polyamines include, but are not limited to, amine-terminated hydrocarbons, amine-terminated polyethers, amine-terminated polyesters, amine-terminated polycarbonates, amine-terminated polycaprolactones, and mixtures thereof. These long-chain polyamines may be used singly, or two or more may be used in combination.

An amine curing agent is an amine compound which has on the molecule at least two amino groups capable of reacting with isocyanate groups and which has a number-average molecular weight of less than 1,000. In this invention, the number-average molecular weight is more preferably less than 800, and even more preferably less than 600. Specific examples of such amine curing agents include, but are not limited to, ethylenediamine, hexamethylenediamine, 1-methyl-2,6-cyclohexyldiamine, tetrahydroxypropylene ethylenediamine, 2,2,4- and 2,4,4-trimethyl-1,6-hexanediamine, 4,4′-bis(sec-butylamino)dicyclohexylmethane, 1,4-bis(sec-butylamino)cyclohexane, 1,2-bis(sec-butylamino)cyclohexane, derivatives of 4,4′-bis(sec-butylamino)dicyclohexylmethane, 4,4′-dicyclohexylmethanediamine, 1,4-cyclohexane bis(methylamine), 1,3-cyclohexane bis(methylamine), diethylene glycol di(aminopropyl) ether, 2-methylpentamethylenediamine, diaminocyclohexane, diethylenetriamine, triethylenetetranine, tetraethylenepentamine, propylenediamine, 1,3-diaminopropane, dimethylaminopropylamine, diethylaminopropylamine, dipropylenetriamine, imidobis(propylamine), monoethanolamine, diethanolamine, triethanolamine, monoisopropanolamine, diisopropanolamine, isophoronediamine, 4,4′-methylenebis(2-chloroaniline), 3,5-dimethylthio-2,4-toluenediamine, 3,5-dimethylthio-2,6-toluenediamine, 3,5-diethylthio-2,4-toluenediamine, 3,5-diethylthio-2,6-toluenediamine, 4,4′-bis(sec-butylamino)diphenylmethane and derivatives thereof, 1,4-bis(sec-butylamino)benzene, 1,2-bis(sec-butylamino)benzene, N,N′-dialkylaminodiphenylmethane, N,N,N′,N′-tetrakis(2-hydroxvpropyl)ethylenediamine, trimethylene glycol di-p-aminobenzoate, polytetramethylene oxide di-p-aminobenzoate, 4,4′-methylenebis(3-chloro-2,6-diethyleneaniline), 4,4′-methylenebis(2,6-diethylaniline), m-phenylenediamine, p-phenylenediamine and mixtures thereof. These amine curing agents may be used singly or two or more may be used in combination.

(iii) Polyol

Although not an essential ingredient, in addition to above components (i) and (ii), a polyol may also be included in the polyurea. The polyol is not particularly limited, but is preferably one that has hitherto been used in the art relating to polyurethanes. Specific examples include the long-chain polyols and/or polyol curing agents mentioned below.

The long-chain polyol may be any that has hitherto been used in the art relating to polyurethanes. Examples include, but are not limited to, polyester polyols, polyether polyols, polycarbonate polyols, polyester polycarbonate polyols, polyolefin-based polyols, conjugated diene polymer-based polyols, castor oil-based polyols, silicone-based polyols and vinyl polymer-based polyols. These long-chain polyols may be used singly or two or more may be used in combination.

The long-chain polyol has a number-average molecular weight of preferably from 1.000 to 5,000, and more preferably from 1,700 to 3,500. In this average molecular weight range, an even better resilience and productivity are obtained.

The polyol curing agent is preferably one that has hitherto been used in the art relating to polyurethanes, but is not subject to any particular limitation. In this invention, use may be made of a low-molecular-weight compound having on the molecule at least two active hydrogen atoms capable of reacting with isocyanate groups and having a molecular weight of less than 1,000. Of these, the use of aliphatic diols having from 2 to 12 carbon atoms is preferred. Specific examples include 1,4-butylene glycol, 1,2-ethylene glycol, 1,3-butanediol, 1,6-hexanediol and 2,2-dimethyl-1,3-propanediol. The use of 1,4-butylene glycol is especially preferred. The polyol curing agent has a number-average molecular weight of preferably less than 800, and more preferably less than 600.

A known method may be used to produce the poly urea. A prepolymer process, a one-shot process or some other known method may be suitably selected for this purpose.

Component (I) has a material hardness on the Shore D hardness scale which, from the standpoint of the spin properties and scuff resistance that can be obtained in the golf ball, is preferably 65 or less, more preferably 60 or less, and even more preferably 55 or less. From the standpoint of the moldability, the lower limit in the material hardness on the Shore D scale is preferably at least 25, and more preferably at least 30.

Component (I) serves as the base resin of the resin composition. To fully impart the scuff resistance of the urethane resin, it accounts for at least 50 wt %, preferably at least 60 wt %, more preferably at least 70 wt %, even more preferably at least 80 wt %/o, and most preferably at least 90 wt %, of the resin composition.

### (II) Aromatic Vinyl Elastomer

Next, the aromatic vinyl elastomer (II) is described.

The aromatic vinyl elastomer is a polymer (elastomer) comprising a polymer block composed primarily of an aromatic vinyl compound, and a random copolymer block consisting of an aromatic vinyl compound and a conjugated diene compound. That is, the aromatic vinyl elastomer generally has, as exemplified by SEBS, blocks consisting of an aromatic vinyl compound component which are located at both ends of the polymer and serve as hard segments, and a block consisting of a conjugated diene compound component which is located between the ends and serves as a soft segment. Polymers wherein an aromatic vinyl-based component has been randomly introduced into the conjugated diene compound component making up the intermediate block have also been reported in recent research. The hardness of the aromatic vinyl elastomer generally becomes lower with a decreasing content of the aromatic vinyl that forms the hard segments, at the same time, because the amount of the soft segment component increases, the resilience rises. On the other hand, in cases where the aromatic vinyl component is randomly introduced into the soft segments of the intermediate block, the resilience decreases with little if any rise in the hardness. A similar effect can be obtained by using a conjugated diene compound having a high glass transition temperature (Tg) in place of the aromatic vinyl compound that is randomly introduced into the intermediate block. In the present invention, to fully exhibit the above working effect, it is particularly desirable to use the above polymer (elastomer) in a hydrogenated form.

Examples of the aromatic vinyl compound in the polymer include styrene, α-methylstyrene, p-methylstyrene, divinylbenzene, 1,1-diphenylethylene, N,N-dimethyl-p-aminoethylstyrene and N,N-diethyl-p-aminoethylstyrene. These may be used singly, or two or more may be used together. Of these aromatic vinyl compounds, styrene is preferred.

Examples of the conjugated diene compound in the polymer include butadiene, isoprene, 2,3-dimethyl-1,3-butadiene, 1,3-pentadiene, 2-methyl-1,3-pentadiene and 1,3-hexadiene. These may be used singly, or two or more may be used together. Of these compounds, butadiene and isoprene are preferred. Butadiene is more preferred.

Units originating from the above conjugated diene compounds, such as units originating from butadiene, become ethylene units or butylene units when subjected to hydrogenation. For example, when a styrene-butadiene-styrene block copolymer (SBS) is hydrogenated, it becomes a styrene-ethylene/butylene-styrene block copolymer (SEBS).

As mentioned above, it is preferable for the aromatic vinyl elastomer used as component (II) to be one that has been hydrogenated; i.e., a hydrogenated aromatic vinyl elastomer. The hydrogenated vinyl elastomer is preferably an elastomer obtained by hydrogenating a polymer comprising a polymer block composed primarily of an aromatic vinyl compound and a random copolymer block consisting of an aromatic vinyl compound and a conjugated diene compound, and more preferably an elastomer obtained by hydrogenating a polymer comprising a polymer block composed primarily of styrene and a random copolymer blocks consisting of styrene and butadiene. An elastomer obtained by hydrogenating a polymer having a polymer block composed primarily of styrene and a random copolymer block consisting of styrene and butadiene, particularly one having at each of two ends a polymer block composed primarily of styrene (in particular, one having at each of the two ends a polymer block consisting entirely of styrene) and having in between a random copolymer block, is especially preferred. It is thought that, by using a copolymer having this structure, a lower hardness and a lower resilience are both achieved. In addition, the rate of solidification after molding is rapid, and so the degree of tack is low. Also, the compatibility with the polyurethane or polyurea (I) serving as the chief ingredient is excellent, enabling any decreases in the physical properties owing to the blend to be held to a minimum.

Illustrative examples of the hydrogenated aromatic vinyl elastomer include styrene-ethylene/butylene-styrene block copolymers (SEBS), styrene-isobutylene-styrene block copolymers (SIBS), styrene-isoprene-styrene block copolymers (SIS), styrene-isobutylene block copolymers (SIB), styrene-ethylene/propylene-styrene block copolymers (SEPS), styrene-ethylene/ethylene/propylene-styrene block copolymers (SEEPS), styrene-butadiene/butylene-styrene block copolymers (SBBS) and styrene-ethylene-propylene block copolymers (SEP).

In the aromatic vinyl elastomer, the proportion of the copolymer accounted for by units originating from the aromatic vinyl compound (i.e., the aromatic vinyl compound content, preferably the styrene content) is preferably at least 45 wt %, more preferably at least 50 wt %, and even more preferably at least 55 wt %. The upper limit of the aromatic vinyl compound content is preferably at most 70 wt %, and more preferably at most 65 wt %. By thus setting the aromatic vinyl compound content, preferably the styrene content, to a high level, the compatibility with the polyurethane or polyurea serving as component (I) is good and, moreover, a worsening of the desired hardness and moldability can be prevented. The content of units from the above aromatic vinyl compound (preferably the styrene content) can be determined by calculation from H¹-NMR measurements.

In the aromatic vinyl elastomer, the glass transition temperature (Tg), as indicated by the tan S peak temperature obtained by dynamic viscoelasticity measurement with a dynamic mechanical analyzer (DMA), is preferably from −20 to 50° C., more preferably at least 0° C., and even more preferably at least 5° C. The thinking here is that, by having the tan δ peak temperature be close to the temperature at which the golf ball is generally used, the resilience of the overall resin composition is kept low in the temperature region at which the golf ball is generally used, enabling the desired effects of the invention to be increased.

A commercial product may be used as the aromatic vinyl elastomer serving as component (II). Examples of such commercial products include those available under the trademarks S.O.E., TUFTEC and TUFPREN from Asahi Kasei Corporation, and those available under the trade name DICSTYRENE from DIC Corporation.

Component (II) has a rebound resilience, as measured according to JIS-K 6255, which is preferably 35% or less, more preferably 30% or less, and even more preferably 25% or less. By thus keeping the rebound resilience very low, a small amount of addition will not have an adverse influence on the golf ball properties, enabling a decrease in the ball initial velocity on approach shots to be achieved. To minimize the decrease in rebound and the reduction in distance on shots with a driver, the lower limit of this rebound resilience is preferably at least 10%, more preferably at least 15%, and even more preferably at least 18%.

Component (II) has a material hardness on the Shore D hardness scale which, from the standpoint of the enhancement of the spin properties on approach shots, is preferably 40 or less, more preferably 33 or less, and even more preferably 27 or less. On the other hand, the lower limit in the material hardness on the Shore D scale is preferably at least 10, more preferably at least 15, and even more preferably at least 20.

The content of component (II) is preferably 30 parts by weight or less, more preferably 25 parts by weight or less, and even more preferably 15 parts by weight or less, per 100 parts by weight of component (I). The lower limit in this content is preferably at least 0.1 part by weight, more preferably at least 0.2 part by weight, and even more preferably at least 0.5 part by weight. When the content of component (II) is too high, the scuff resistance and moldability may worsen. On the other hand, when the content of component (II) is too low, the low hardness as a cover resin material and the desired resilience may not be obtained, and the ball initial velocity lowering effect on approach shots may diminish.

### (III) Thermoplastic Polyester Elastomer

In this invention, a specific thermoplastic polyester elastomer may be included as an optional ingredient in the resin composition. This specific thermoplastic polyester elastomer imparts at least a certain degree of resilience to the resin composition and, along with imparting such resilience, enables the ball to maintain an elevated spin rate at or above a certain level on approach shots. Also, because the specific thermoplastic polyester elastomer in the resin composition has a good compatibility with component (I) serving as the base resin, it is able to impart the ball with a good scuff resistance. In addition, including the specific thermoplastic polyester elastomer in the resin composition provides the resin composition with at least a certain level of melt viscosity, thus imparting hardenability to the resin composition after it has been molded. That is, the thermoplastic polyester elastomer suppresses a decline in the viscosity of the overall resin composition due to the softness of component (I) serving as the base resin, thus preventing a decrease in moldability (productivity) and an increase in appearance defects in the molded golf balls and also holding down a rise in production costs due to an increased cooling time. This thermoplastic polyester elastomer is described below.

The thermoplastic polyester elastomer serving as component (III) is a resin composition made up of (b-1) a polyester block copolymer and (b-2) a rigid resin. In turn, component (b-1) is made up of (b-1-1) a high-melting crystalline polymer segment and (b-1-2) a low-melting polymer segment.

The high-melting crystalline polymer segment (b-1-1) within the polyester block copolymer serving as component (b-1) is a polyester formed from one or more compound selected from the group consisting of aromatic dicarboxylic acids and ester-forming derivatives thereof and diols and ester-forming derivatives thereof.

Illustrative examples of the aromatic dicarboxylic acids include terephthalic acid, isophthalic acid, phthalic acid, 2,6-naphthalenedicarboxylic acid, 2,7-naphthalenedicarboxylic acid, anthracenedicarboxylic acid, diphenyl-4,4′-dicarboxylic acid, diphenoxyethanedicarboxylic acid, 4,4′-diphenyletherdicarboxylic acid, 5-sulfoisophthalic acid and sodium 3-sulfoisophthalate. In this invention, an aromatic dicarboxylic acid is primarily used. However, where necessary, some of this aromatic dicarboxylic acid may be replaced with an alicyclic dicarboxylic acid such as 1,4-cyclohexanedicarboxylic acid, cyclopentanedicarboxylic acid or 4,4′-dicyclohexyldicarboxylic acid or with an aliphatic dicarboxylic acid such as adipic acid, succinic acid, oxalic acid, sebacic acid, dodecanedioic acid or a dimer acid. Exemplary ester-forming derivatives of dicarboxylic acids include lower alkyl esters, aryl esters, carboxylic acid esters and acid halides of the above dicarboxylic acids.

Next, a diol having a molecular weight of 400 or less may be suitably used as the diol. Specific examples include aliphatic diols such as 1,4-butanediol, ethylene glycol, trimethylene glycol, pentamethylene glycol, hexamethylene glycol, neopentyl glycol and decamethylene glycol; alicyclic diols such as 1,1-cyclohexanedimethanol, 1,4-dicyclohexanedimethanol and tricyclodecanedimethanol; and aromatic diols such as xylylene glycol, bis(p-hydroxy)diphenyl, bis(p-hydroxy)diphenylpropane, 2,2′-bis[4-(2-hydroxyethoxy)phenyl]propane, bis[4-(2-hydroxyethoxy)phenyl]sulfone, 1,1-bis[4-(2-hydroxyethoxy)phenyl]cyclohexane, 4,4′-dihydroxy-p-terphenyl and 4,4′-dihydroxy-p-quaterphenyl. Exemplary ester-forming derivatives of diols include acetylated forms and alkali metal salts of the above diols.

These aromatic dicarboxylic acids, diols and derivatives thereof may be used singly or two or more may be used together.

In particular, the following may be suitably used as component (b-1-1): high-melting crystalline polymer segments composed of polybutylene terephthalate units derived from terephthalic acid and/or dimethyl terephthalate together with 1,4-butanediol; high-melting crystalline polymer segments composed of polybutylene terephthalate units derived from isophthalic acid and/or dimethyl isophthalate together with 1,4-butanediol; and copolymers of both.

The low-melting polymer segment serving as component (b-1-2) is an aliphatic polyether and/or an aliphatic polyester.

Examples of the aliphatic polyether include poly(ethylene oxide) glycol, poly(propylene oxide) glycol, poly(tetramethylene oxide) glycol, poly(hexamethylene oxide) glycol, copolymers of ethylene oxide and propylene oxide, ethylene oxide addition polymers of poly(propylene oxide) glycol, and copolymer glycols of ethylene oxide and tetrahydrofuran. Examples of aliphatic polyesters include poly(ε-caprolactone), polyenantholactone, polycaprolactone, polybutylene adipate and polyethylene adipate. In this invention, from the standpoint of the elastic properties, suitable use can be made of poly(tetramethylene oxide) glycol, ethylene oxide adducts of poly(propylene oxide) glycol, copolymer glycols of ethylene oxide and tetrahydrofuran, poly(ε-caprolactone), polybutylene adipate and polyethylene adipate. Of these, the use of, in particular, poly(tetramethylene oxide) glycol, ethylene oxide adducts of poly(propylene oxide) glycol and copolymer glycols of ethylene oxide and tetrahydrofuran is recommended. The number-average molecular weight of these segments in the copolymerized state is preferably from about 300 to about 6,000.

Component (b-1) can be produced by a known method. Specifically, use can be made of, for example, the method of carrying out a transesterification reaction on a lower alcohol diester of a dicarboxylic acid, an excess amount of a low-molecular-weight glycol and a low-melting polymer segment component in the presence of a catalyst and polycondensing the resulting reaction product, or the method of carrying out an esterification reaction on a dicarboxylic acid, an excess amount of glycol and a low-melting polymer segment component in the presence of a catalyst and polycondensing the resulting reaction product.

The proportion of component (b-1) accounted for by component (b-1-2) is from 30 to 60 wt %. The preferred lower limit in this case can be set to 35 wt % or more, and the preferred upper limit can be set to 55 wt % or less. When the proportion of component (b-1-2) is too low, the impact resistance (especially at low temperatures) and the compatibility may be inadequate. On the other hand, when the proportion of component (b-1-2) is too high, the rigidity of the resin composition (and the molded body) may be inadequate.

The rigid resin serving as component (b-2) is not particularly limited. For example, one or more selected from the group consisting of polycarbonates, acrylic resins, styrene resins such as ABS resins and polystyrenes, polyester resins, polyamide resins, polyvinyl chlorides and modified polyphenylene ethers may be used. In this invention, from the standpoint of compatibility, a polyester resin may be suitably used. More preferably, the use of polybutylene terephthalate and/or polybutylene naphthalate is recommended.

Component (b-1) and component (b-2) are blended in a ratio, expressed as (b-1):(b-2), which is not particularly limited, although this ratio by weight is preferably set to from 50:50 to 90:10, and more preferably from 55:45 to 80:20. When the proportion of component (b-1) is too low, the low-temperature impact resistance may be inadequate. On the other hand, when the proportion of (b-1) is too high, the rigidity of the composition (and the molded body), as well as the molding processability, may be inadequate.

A commercial product may be used as the polyester elastomer (III). Specific examples include those available as Hytrel® from DuPont-Toray Co. Ltd.

Component (III) has a material hardness on the Shore D hardness scale which, to enhance the spin rate on approach shots, is preferably 50 or less, more preferably 46 or less, and even more preferably 43 or less. The lower limit is a Shore D hardness of preferably at least 20, more preferably at least 25, and even more preferably at least 30.

Component (III) has a rebound resilience which, to enhance the spin rate on approach shots, is preferably at least 50%, more preferably at least 55%, and even more preferably at least 60%. The upper limit is preferably 80% or less, more preferably 77% or less, and even more preferably 75% or less. The rebound resilience is measured according to JIS-K 6255: 2013.

Component (III) has a melt viscosity which is preferably at least 0.3×10⁴ dPa·s, and more preferably at least 0.4×10⁴ dPa·s. The upper limit is preferably not more than 1.5×10⁴ dPa·s, more preferably not more than 1.0×10⁴ dPa·s, and even more preferably not more than 0.8×10⁴ dPa·s. With this melt viscosity, hardenability after molding of the resin composition is imparted and a decrease in moldability (productivity) can be suppressed. This melt viscosity indicates the value measured with a capillary viscometer at a temperature of 200° C. and a shear rate of 243 sec⁻¹ in accordance with ISO 11443: 1995.

Component (Ill) is blended in a proportion which is preferably at least 3 wt %, more preferably at least 5 wt %, and even more preferably at least 10 wt %, of the resin composition. The upper limit is preferably not more than 30 wt %, more preferably not more than 25 wt %, and more preferably not more than 15 wt %. At above this value, decreases in the moldability and the scuff resistance may occur.

In addition to the resin components described above, other resin materials may be included in the resin composition containing components (I) and (II), and optionally component (IIII). The purposes for doing so are, for example, to further improve the flowability of the golf ball resin composition and to increase such ball properties as the rebound and the scuff resistance.

Specific examples of other resin materials that may be used include polyester elastomers, polyamide elastomers, ionomer resins, ethylene-ethylene/butylene-ethylene block copolymers and modified forms thereof, polyacetals, polyethylenes, nylon resins, methacrylic resins, polyvinyl chlorides, polycarbonates, polyphenylene ethers, polyarylates, polysulfones, polyethersulfones, polyetherimides and polyamideimides. These may be used singly or two or more may be used together.

In addition, an active isocyanate compound may be included in the above resin composition. This active isocyanate compound reacts with the polyurethane or polyurea serving as the base resin, enabling the scuff resistance of the overall resin composition to be further increased. Moreover, the isocyanate has a plasticizing effect which increases the flowability of the resin composition, enabling the moldability to be improved.

Any isocyanate compound employed in conventional polyurethanes may be used without particular limitation as the above isocyanate compound. For example, aromatic isocyanate compounds that may be used include 2,4-toluene diisocyanate, 2,6-toluene diisocyanate and mixtures of both, 4,4-diphenylmethane diisocyanate, m-phenylene diisocyanate and 4,4′-biphenyl diisocyanate. Use can also be made of the hydrogenated forms of these aromatic isocyanate compounds, such as dicyclohexylmethane diisocyanate.

Other isocyanate compounds that may be used include aliphatic diisocyanates such as tetramethylene diisocyanate, hexamethylene diisocyanate (HDI) and octamethylene diisocyanate; and alicyclic diisocyanates such as xylene diisocyanate. Further examples of isocyanate compounds that may be used include blocked isocyanate compounds obtained by reacting the isocyanate groups on a compound having two or more isocyanate groups on the ends with a compound having active hydrogens, and uretdiones obtained by the dimerization of isocyanate.

The amount of the above isocyanate compounds included per 100 parts by weight of the polyurethane or polyurea resin serving as the base resin is preferably at least 0.1 part by weight, and more preferably at least 0.5 part by weight. The upper limit is preferably not more than 30 parts by weight, and more preferably not more than 20 parts by weight. When too little is included, a sufficient crosslinking reaction may not be obtained and an increase in the properties may not be observable. On the other hand, when too much is included, discoloration over time due to heat and ultraviolet light may increase, or problems such as a loss of thermoplasticity or a decline in resilience may arise.

In addition, optional additives may be suitably included in the above resin composition according to the intended use thereof. For example, when the golf ball resin composition is to be used as a cover material, various additives, such as inorganic fillers, organic staple fibers, reinforcing agents, crosslinking agents, pigments, dispersants, antioxidants, ultraviolet absorbers and light stabilizers, may be added to the ingredients described above. When such additives are included, the amount thereof per 100 parts by weight of the base resin is preferably at least 0.1 part by weight, and more preferably at least 0.5 part by weight, but preferably not more than 10 parts by weight, and more preferably not more than 4 parts by weight.

When the rebound resilience of the resin composition is too high, it has a distance-increasing effect on shots with a driver, but the ball initial velocity on approach shots is likewise high, making the ball difficult to control. For this reason, it is preferable for the rebound resilience, as measured in accordance with JIS-K 6255, to be 65% or less. In order to minimize decreases in the rebound and the distance of the ball on shots with a driver, it is preferable for this rebound resilience to be at least 30%.

The resin composition has a material hardness on the Shore D hardness scale which, in terms of the spin properties and scuff resistance of the golf ball, is preferably 60 or less, more preferably 55 or less, even more preferably 50 or less, and most preferably 45 or less. From the standpoint of moldability, the Shore D hardness is preferably at least 20, and more preferably at least 30.

The above resin composition may be prepared by mixing together the ingredients using any of various types of mixers, such as a kneading-type single-screw or twin-screw extruder, a Banbury mixer, a kneader or a Labo Plastomill. Alternatively, the ingredients may be mixed together by dry blending when the resin composition is to be injection-molded. In addition, when an active isocyanate compound is used, it may be incorporated at the time of resin mixture using various types of mixers, or a resin masterbatch already containing the active isocyanate compound and other ingredients may be separately prepared and the various components mixed together by dry blending when the resin composition is to be injection-molded.

The method of molding a cover layer from the above resin composition may involve, for example, feeding the resin composition into an injection molding machine and molding the cover layer by injecting the molten resin composition over a core. In this case, the molding temperature differs according to the type of polyurethane or polyurea (I) serving as the chief ingredient, but is typically in the range of 150 to 270° C.

In the golf ball of this invention, letting HMa (N/mm²) be the Martens hardness of the resin material of component (I) and HMb (N/mm²) be the Martens hardness of the cover layer formed of the resin composition containing components (I) and (II), to obtain a good controllability on approach shots while maintaining a good scuff resistance, it is critical for the ball to satisfy formula (1) below.

0.990≤HMa/HMb≤1.500 (1)

The lower limit of formula (1) is at least 0.990 and preferably at least 1.000. The upper limit is not more than 1.500, preferably not more than 1.300, and more preferably not more than 1.200. When the formula (1) value is too large, the scuff resistance decreases. On the other hand, when it is too small, the controllability of the ball on approach shots decreases.

The Martens hardness HMa of the resin material of component (I) has a lower limit of preferably at least 10.00 N/mm², and more preferably at least 11.00 N/mm². The upper limit is preferably not more than 30.00 N/mm², and more preferably not more than 25.00 N/mm².

The Martens hardness HMb of the cover layer formed of the resin composition containing components (I) and (11) has a lower limit of preferably at least 8.00 N/mm², and more preferably at least 9.00 N/mm². The upper limit is preferably not more than 28.00 N/mm², and more preferably not more than 23.00 N/mm².

The Martens hardnesses HMa and HMb can be measured with a nanohardness tester based on ISO 14577: 2002 (“Metallic materials—Instrumented indentation test for hardness and materials parameters”). This is a physical value determined by pressing an indenter into the object being measured while applying a load to the indenter, and is calculated as (indentation force [N])/(surface area of region to which pressure is applied [mm²]). Measurement of the Martens hardness may be carried out using, for example, the nanohardness tester available from Fischer Instruments under the product name Fischerscope HM2000. This instrument can, for example, measure the hardness of the cover while continuously increasing the load in a stepwise manner. The nanohardness test conditions may be set to room temperature, 10 seconds, and an applied load of 50 mN.

When measuring the surface of the cover, in cases where a coat or the like has been formed on the cover surface, specifying the surface hardness is difficult. Also, deep positions from the cover surface toward the center of the ball are affected by the hardness of the adjacent layer. In light of such considerations, the Martens hardness inherent to the cover can be stably obtained at a position 0.3 mm from the cover surface toward the center of the ball. Hence, it is desirable to measure the Martens hardness at this position.

Also, letting ηItb (%) be the elastic work recovery of the cover layer, to obtain a good controllability on approach shots while maintaining a good scuff resistance, together with formula (1) above, it is preferable to satisfy formula (2) below.

2.00≤ηItb/HMb≤7.00 (2)

The formula (2) value has a lower limit of preferably at least 2.00, more preferably at least 3.00—and even more preferably at least 4.00. The upper limit is not more than 7.00, preferably not more than 6.70, and more preferably not more than 6.40. At a formula (2) value that is too large or too small, the scuff resistance may worsen.

The elastic work recovery ηItb of the cover layer has a lower limit of preferably at least 50%, and more preferably at least 55%. The upper limit is preferably not more than 85%, and more preferably not more than 80%.

In addition, letting the elastic work recovery of the resin material of component (I) be ηIta [%], it is preferable to satisfy formula (3) below.

0.980≤ηIta/ηItb≤1.050 (3).

The formula (3) value has a lower limit of preferably at least 0.980, and an upper limit of preferably not more than 1.050 and more preferably not more than 1.040.

The elastic work recovery ηIta of the resin material of component (I) has a lower limit of preferably at least 45%, and more preferably at least 500%. The upper limit is preferably not more than 80%, and more preferably not more than 75%.

At elastic work recoveries ηOta and ηItb in these ranges, the cover formed at the golf ball surface has a high self-repairing/recovering ability while maintaining a fixed hardness and elasticity, and is able to contribute to the excellent durability and scuff resistance of the ball. Moreover, even when the Martens hardness is low, in cases where the elastic recoveries are too low, the ball has a good spin performance on approach shots but a poor scuff resistance. The method of measuring the elastic work recoveries is described below.

The above elastic work recoveries serve as parameters of the nanoindentation method for evaluating the physical properties of the cover, this being a nanohardness test method that controls the indentation load on a micro-newton (μN) order and tracks the indenter depth during indentation to a nanometer (nm) precision. In prior methods, only the size of the deformation (plastic deformation) mark corresponding to the maximum load could be measured. However, in the nanoindentation method, the relationship between the indentation load and the indentation depth can be obtained by continuous automated measurement. This eliminates the problem up until now of individual differences between observers when visually measuring a deformation mark under an optical microscope, enabling the physical properties of the cover to be reliably measured to a high precision. Given that the golf ball cover is strongly affected by the impact of drivers and other clubs and has a not inconsiderable influence on various golf ball properties, measuring the cover by the nanohardness test method and carrying out such measurement to a higher precision than in the past is a very effective method of evaluation.

Moreover, from the standpoint of the enhancement of the inventive desirable effects, it is preferable to satisfy formula (4) below.

0.800≤(ηIta·HMb)/(ηItb·HMa)≤1.050 (4).

The formula (4) value has a lower limit of preferably at least 0.800, more preferable at least 0.850, and even more preferable at least 0.900. The upper limit is not more than 1.050 and more preferably not more than 1.040.

The cover has a thickness of preferably at least 0.4 mm, more preferably at least 0.5 mm, and even more preferably at least 0.6 mm. The upper limit is preferably not more than 3.0 mm, and more preferably not more than 2.0 mm.

One or more intermediate layer may be interposed between the above core and the above cover. In this case, it is preferable to employ any of various types of thermoplastic resins used in golf ball cover materials, especially an ionomer resin, as the intermediate layer material. A commercial product may be used as the ionomer resin.

In the golf ball of the invention, for reasons having to do with the aerodynamic performance, numerous dimples are provided on the surface of the outermost layer. The number of dimples formed on the surface of the outermost layer is not particularly limited. However, to enhance the aerodynamic performance and increase the distance traveled by the ball, this number is preferably at least 250, more preferably at least 270, even more preferably at least 290, and most preferably at least 300. The upper limit is preferably not more than 400, more preferably not more than 380, and even more preferably not more than 360.

In this invention, a coating layer is formed on the cover surface. A two-part curable urethane coating may be suitably used as the coating that forms this coating layer. Specifically, in this case, the two-part curable urethane coating is one that includes a base resin composed primarily of a polyol resin and a curing agent composed primarily of a polyisocyanate.

A known method may be used without particular limitation as the method for applying this coating onto the cover surface and forming a coating layer. Use can be made of a desired method such as air gun painting or electrostatic painting.

The thickness of the coating layer, although not particularly limited, is typically from 8 to 22 μm, and preferably from 10 to 20 μm.

The golf ball of the invention can be made to conform to the Rules of Golf for play. The inventive ball may be formed to a diameter which is such that the ball does not pass through a ring having an inner diameter of 42.672 mm and is not more than 42.80 mm, and to a weight which is preferably between 45.0 and 45.93 g.

### EXAMPLES

The following Examples and Comparative Examples are provided to illustrate the invention, and are not intended to limit the scope thereof.

### Examples 1 to 8, Comparative Examples 1 to 5

In Examples and Comparative Examples, a core-forming rubber composition formulated as shown in Table 1 and common to all of the Examples was prepared and then molded and vulcanized to produce a 38.6 mm diameter core.

TABLE 1

| Rubber composition | parts by weight |
|---|---|
| cis-1,4-Polybutadiene | 100 |
| Zinc acrylate | 27 |
| Zinc oxide | 4.0 |
| Barium sulfate | 16.5 |
| Antioxidant | 0.2 |
| Organic peroxide (1) | 0.6 |
| Organic peroxide (2) | 1.2 |
| Zinc salt of pentachlorothiophenol | 0.3 |
| Zinc stearate | 1.0 |

Details on the above core material are given below.
Cis-1,4-Polybutadiene: Available under the trade name “BR 01” from JSR Corporation
Zinc acrylate: Available from Nippon Shokubai Co., Ltd.
Zinc oxide: Available from Sakai Chemical Co., Ltd.
Barium sulfate: Available from Sakai Chemical Co., Ltd.
Antioxidant: Available under the trade name “Nocrac NS6” from Ouchi Shinko Chemical Industry Co., Ltd.
Organic peroxide (1): Dicumyl peroxide, available under the trade name “Percumyl D” from NOF Corporation
Organic peroxide (2): A mixture of 1,1-di(tert-butylperoxy)cyclohexane and silica, available under the trade name “Perhexa C-40” from NOF Corporation
Zinc stearate: Available from NOF Corporation

Next, in Examples and Comparative Examples, an intermediate layer-forming resin material common to all of the Examples was formulated. This intermediate layer resin material was a blend of 50 parts by weight of a sodium-neutralized ethylene-unsaturated carboxylic acid copolymer having an acid content of 18 wt % and 50 parts by weight of a zinc-neutralized ethylene-unsaturated carboxylic acid copolymer having an acid content of 15 wt % (for a combined amount of 100 parts by weight). This resin material was injection molded over a core having a diameter of 38.6 mm, thereby producing an intermediate layer-encased sphere having an intermediate layer with a thickness of 1.25 mm.

Next, the cover materials shown in Tables 2 and 3 below were injection-molded over the intermediate layer-encased spheres in the amounts indicated in these tables, thereby producing 42.7 mm diameter three-piece golf balls having a cover layer (outermost layer) with a thickness of 0.8 mm. Although not shown in the diagram, dimples common to all of the Examples and Comparative Examples were formed on the surface of the cover.

### Preparation of Cover (Outermost Laver)-Forming Resin Composition

The ingredients are mixed in the amounts shown in Tables 2 and 3 by dry blending, and the resulting resin compositions are injection-molded at a molding temperature of between 210° C. and 250° C.

Details on the ingredients included in the compositions in Tables 2 and 3 are given below.
TPU 4: An aromatic ether-type thermoplastic polyurethane available from DIC Covestro Polymer, Ltd. under the trade name “Pandex” (Shore D hardness, 43)
S.O.E. S1611:
   A hydrogenated aromatic vinyl elastomer available from Asahi Kasei Corporation
   (styrene content, 60 wt %; Shore D hardness, 23; rebound resilience, 20%)
Tuftec H1051:
   A hydrogenated aromatic vinyl elastomer available from Asahi Kasei Corporation
   (styrene content, 42 wt %; Shore D hardness, 45; rebound resilience, 40%)
Tuftec H1517:
   A hydrogenated aromatic vinyl elastomer available from Asahi Kasei Corporation
   (styrene content, 43 wt %; Shore D hardness, 47; rebound resilience, 28%)
Hytrel 2401:
   A polyester elastomer available from DuPont-Toray Co., Ltd.
   (Shore D hardness, 40; rebound resilience, 67%)
Hytrel 3001:
   A polyester elastomer available from DuPont-Toray Co., Ltd.
   (Shore D hardness, 30; rebound resilience, 75%)
Hytrel 4001:
   A polyester elastomer available from DuPont-Toray Co., Ltd.
   (Shore D hardness, 37; rebound resilience, 73%)

### Properties of Component (III)

### (1) Rebound Resilience:

The rebound resiliences of the resin compositions measured in accordance with JIS-K 6255: 2013 are shown in Tables 2 and 3.

### (2) Melt Viscosity:

The melt viscosities measured with a capillary viscometer at a temperature of 200° C. and a shear rate of 243 sec⁻¹ in accordance with ISO 11443: 1995 are shown in Tables 2 and 3.

The Martens hardnesses (HMa) and elastic work recoveries (ηIta) of the polyurethane resins (TPU4) used in the Examples and the Comparative Examples are respectively measured by the methods described below. In addition, the Martens hardnesses (HMb) and elastic work recoveries (ηItb) of the cover layer (outermost layer) resin compositions used in the Examples and Comparative Examples are each measured. Next, the four following relationships among these parameters are calculated:

HMa/HMb Formula (1):

ηItb/HMb, Formula (2):

ηIta/ηItb, and Formula (3):

(ηIta·HMb)/(ηItb·HMa) Formula (4):

The calculated values are shown in Tables 2 and 3.

### Martens Hardness (HMb) of Outermost Layer (Cover Layer)

The golf ball in each example is cut in half and, specifying a position on the ball cross-section that is located 0.3 mm from the surface of the cover toward the ball center, the Martens hardness HMa (N/mm²) at this place is measured using the nanohardness tester available from Fischer Instruments under the product name Fischerscope HM2000. The nanohardness measurement conditions are room temperature and an applied load of 50 mN/10 s.

### Martens Hardness (HMa) of Resin Material

The Martens hardnesses (HMa) obtained for the respective polyurethane resins (TPU4) are shown below. The apparatus and conditions used for measuring the Martens hardnesses of these resins are the same as those mentioned above.
Martens hardness (HMa) of TPU4: 14.3 N/mm²

### Elastic Work Recovery of Cover Laver (Outermost Layer)

The elastic work recovery of the cover is measured using the nanohardness tester available from Fischer Instruments under the product name Fischerscope HM2000. The measurement conditions are room temperature and an applied load of 50 mN/10 s. The elastic work recovery is calculated as follows, based on the indentation work Wₑₗₐₛₜ (Nm) due to spring-back deformation of the cover and on the mechanical indentation work Wₜₒₜₐₗ (Nm).

Elastic work recovery=Wₑₗₐₛₜ/Wₜₒₜₐₗ×100(%)

### Elastic Work Recovery of Resin Material

The elastic work recoveries (%) of the respective polyurethane resins (TPU4) are shown below. The apparatus and conditions used for measuring the elastic work recoveries of these resins are the same as those mentioned above.
Elastic work recovery of TPU4: 72.0%

### Ball Properties on Approach Shots

For the golf balls obtained in the respective Examples and Comparative Examples, a sand wedge (SW) is mounted on a golf swing robot and the initial velocity and backspin rate of the ball immediately after being struck at a head speed (HS) of 20 m/s is measured to with an apparatus for measuring the initial conditions. With regard to the initial velocity on approach shots, the initial velocity difference relative to Comparative Example 3 as the reference is determined in the respective Examples and Comparative Examples. These measured values and calculated values are shown in Tables 2 and 3.

Sensory evaluations of the club maneuverability on approach shots are carried out based on the following criteria.

Excellent (Exc): Superior maneuverability

Good: Good maneuverability

NG: Inferior maneuverability

### Evaluation of Scuff Resistance

The golf balls are held isothermally at 23° C. and five balls of each type are hit at a head speed of 33 m/s using as the club a pitching wedge mounted on a swing robot machine. The damage to the ball from the impact is visually rated according to the following criteria.

Excellent (Exc): Slight scuffing or substantially no apparent scuffing.

Good: Slight fraying of surface or slight dimple damage.

NG: Dimples completely obliterated in places.

TABLE 2

| | | | Example | | | | | | | |
|---|---|---|---|---|---|---|---|---|---|---|
| | | | 1 | 2 | 3 | 4 | 5 | 6 | 7 | 8 |
| Outermost | Comp | TPU4 | 100 | 100 | 100 | 100 | 100 | 100 | 100 | 100 |
| layer | (I) | | | | | | | | | |
| composition | Comp. | S.O.E. S1611 | 5 | 15 | 5 | 5 | 5 | 5 | 5 | 0.5 |
| (pbw) | (II) | Tuftec H1051 | | | | | | | | |
| | | Tuftec H1517 | | | | | | | | |
| | Comp. | Hytrel 2401 | | | 14.5 | 25 | 7.3 | | | 0.5 |
| | (III) | Hytrel 3001 | | | | | | | 14.5 | |
| | | Hytrel 4001 | | | | | 7.2 | 14.5 | | 14.5 |
| Physical | Comp. | Elastic work | 72.0 | 72.0 | 72.0 | 72.0 | 72.0 | 72.0 | 72.0 | 72.0 |
| properties | (I) | recovery (%) | | | | | | | | |
| | | Martens hardness | 14.3 | 14.3 | 14.3 | 14.3 | 14.3 | 14.3 | 14.3 | 14.3 |
| | | (N/mm²) | | | | | | | | |
| | | Shore D hardness | 43.0 | 43.0 | 43.0 | 43.0 | 43.0 | 43.0 | 43.0 | 43.0 |
| | Comp. | Rebound | 20.0 | 20.0 | 20.0 | 20.0 | 20.0 | 20.0 | 20.0 | 20.0 |
| | (II) | Resilience ( %) | | | | | | | | |
| | | Styrene content | 60.0 | 60.0 | 60.0 | 60.0 | 60.0 | 60.0 | 60.0 | 60.0 |
| | | (wt %) | | | | | | | | |
| | | Shore D hardness | 23.0 | 23.0 | 23.0 | 23.0 | 23.0 | 23.0 | 23.0 | 23.0 |
| | Comp. | Rebound | — | — | 67.0 | 67.0 | 70.0 | 73.0 | 75.0 | 72.8 |
| | (III) | resilience (%) | | | | | | | | |
| | | Shore D hardness | — | — | 40.0 | 40.0 | 38.5 | 37.0 | 30.0 | 37.1 |
| | | Melt viscosity | — | — | 0.57 | 0.57 | 0.92 | 1.28 | 0.45 | 1.26 |
| | | (× 10⁴ dPA · s) | | | | | | | | |
| | Cover | Elastic work | 69.2 | 72.1 | 70.0 | 70.2 | 70.8 | 70.7 | 73.0 | 69.6 |
| | | recovery (%) | | | | | | | | |
| | | Marten hardness | 13.9 | 12.2 | 14.3 | 13.8 | 12.9 | 13.7 | 12.4 | 14.3 |
| | | (N/mm²) | | | | | | | | |
| | | Shore D hardness | 42.0 | 40.4 | 41.8 | 41.7 | 41.6 | 41.4 | 40.6 | 42.1 |

| | | | | | | | | | |
|---|---|---|---|---|---|---|---|---|---|
| Formula (1) | HMa/HMb | 1.031 | 1.176 | 1.000 | 1.035 | 1.111 | 1.047 | 1.155 | 1.000 |
| Formula (2) | ηItb/HMb | 5.331 | 6.339 | 5.227 | 5.427 | 5.883 | 5.531 | 6.302 | 5.048 |
| Formula (3) | ηIta/ηItb | 1.041 | 0.998 | 1.028 | 1.026 | 1.016 | 1.019 | 0.986 | 1.035 |
| Formula (4) | (ηIta · HMb)/(ηItb · HMa) | 1.010 | 0.849 | 1.028 | 0.992 | 0.915 | 0.973 | 0.854 | 1.035 |
| Evaluations | Initial velocity on | 19.35 | 19.29 | 19.33 | 19.32 | 19.34 | 19.35 | 19.37 | 19.30 |
| | approach shots (m/s) | | | | | | | | |
| | Difference With | −0.03 | −0.09 | −0.05 | −0.06 | −0.04 | −0.03 | −0.01 | −0.08 |
| | Comp. Ex. 3 (m/s) | | | | | | | | |
| | Spin rate on | 6,600 | 6,453 | 6,592 | 6,586 | 6,596 | 6,598 | 6,661 | 6,484 |
| | approach shots (rpm) | | | | | | | | |

| | | | | | | | | |
|---|---|---|---|---|---|---|---|---|
| Controllability on approach shots | good | Exc | Exc | Exc | good | good | good | good |
| Scuff resistance | good | good | good | good | good | good | Exc | good |

TABLE 3

| Comparative Example | | | | |
|---|---|---|---|---|
| 1 | 2 | 3 | 4 | 5 |

| | | | | | | | |
|---|---|---|---|---|---|---|---|
| Outermost | Comp | TPU4 | 100 | 100 | 100 | 100 | 100 |
| layer | (I) | | | | | | |
| composition | Comp. | S.O.E. S1611 | | | | | |
| (pbw) | (II) | Tuftec H1051 | 5 | 15 | | | |
| | | Tuftec H1517 | | | | 5 | 15 |
| | Comp. | Hytrel 2401 | | | | | |
| | (III) | Hytrel 3001 | | | | | |
| | | Hytrel 4001 | | | | | |
| Physical | Comp. | Elastic work | 72.0 | 72.0 | 72.0 | 72.0 | 72.0 |
| properties | (I) | recovery (%) | | | | | |
| | | Martens hardness | 14.3 | 14.3 | 14.3 | 14.3 | 14.3 |
| | | (N/mm²) | | | | | |
| | | Shore D hardness | 43.0 | 43.0 | 43.0 | 43.0 | 43.0 |
| | Comp. | Rebound | 40.0 | 40.0 | | 28.0 | 28.0 |
| | (II) | Resilience (%) | | | | | |
| | | Styrene content | 42.0 | 42.0 | | 43.0 | 43.0 |
| | | (wt %) | | | | | |
| | | Shore D hardness | 45.0 | 45.0 | | 47.0 | 47.0 |
| | Comp. | Rebound | | | | | |
| | (III) | resilience (%) | | | | | |
| | | Shore D hardness | | | | | |
| | | Melt viscosity | | | | | |
| | | (× 10⁴ dPA · s) | | | | | |
| | Cover | Elastic work | 69.2 | 66.2 | 72.0 | 68.5 | 63.9 |
| | | recovery (%) | | | | | |
| | | Martens hardness | 14.9 | 14.7 | 14.3 | 14.7 | 15.5 |
| | | (N/mm²) | | | | | |
| | | Shore D hardness | 43.1 | 43.3 | 43.0 | 43.2 | 43.5 |

| | | | | | | |
|---|---|---|---|---|---|---|
| Formula (1) | HMa/HMb | 0.960 | 0.974 | 1.000 | 0.970 | 0.920 |
| Formula (2) | ηItb/HMb | 5.128 | 4.820 | 5.035 | 4.965 | 4.391 |
| Formula (3) | ηIta/ηItb | 1.040 | 1.087 | 1.000 | 1.051 | 1.127 |
| Formula (4) | (ηIta · HMb)/(ηItb · HMa) | 1.083 | 1.117 | 1.000 | 1.084 | 1.226 |
| Evaluations | Initial velocity on | 19.38 | 19.36 | 19.38 | 19.34 | 19.28 |
| | approach shots (m/s) | | | | | |
| | Difference With | 0.00 | −0.02 | reference | −0.04 | −0.10 |
| | Comp. Ex. 3 (m/s) | | | | | |
| | Spin rate on | 6,592 | 6,430 | 6,653 | 6,557 | 6,324 |
| | approach shots (rpm) | | | | | |

| | | | | | |
|---|---|---|---|---|---|
| Controllability on approach shots | NG | NO | NO | NO | NG |
| Scuff resistance | good | good | good | good | good |

As is apparent from the results in Tables 2 and 3, the golf balls in Comparative Examples 1 to 5 were inferior in the following respects to the golf balls obtained in the Examples according to the invention.

In Comparative Examples 1, 2, 4 and 5, the HMa/HMb value is smaller than 0.990 and the cover material did not include the aromatic vinyl elastomer serving as component (II) in the present invention. As a result, the controllability was inadequate.

In Comparative Example 3, the cover material did not include the aromatic vinyl elastomer serving as component (II) in the present invention. As a result, although the golf ball had a high spin rate on approach shots, the initial velocity was high and the controllability was inadequate.

Japanese Patent Application No. 2019-119575 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A golf ball comprising a core of at least one layer and a cover of one or more layer encasing the core, wherein at least one layer of the cover is formed of a resin composition comprising:
(I) a polyurethane or a polyurea, and
(II) an aromatic vinyl elastomer, and
letting HMa (N/mm²) be the Martens hardness of the resin material of component (I), HMb (N/mm²) be the Martens hardness of the cover layer formed of the resin composition containing components (I) and (II), HMa and HMb satisfy formula (1) below
0.990≤HMa/HMb≤1.500 (1)
and wherein the component (II) has a material hardness of from 10 to 40 on the Shore D hardness scale.

2. The golf ball of claim 1 which, letting ηItb (%) be the elastic work recovery of the cover layer, satisfies formula (2) below
2.00≤ηItb/HMb≤7.00 (2).

3. The golf ball of claim 2 which, letting ηIta (%) be the elastic work recovery of the resin material of component (1), satisfies formula (3) below:
0.980≤ηIta/ηItb≤1.050 (3).

4. The golf ball of claim 3, which satisfies formula (4) below
0.800≤(ηIta·HMb)/(ηItb·HMa)≤1.050 (4).

5. The golf ball of claim 1, wherein the content of component (II) is 25 parts by weight or less per 100 parts by weight of component (I).

6. The golf ball of claim 1, wherein the rebound resilience of component (II), as measured according to JIS-K 6255 is from 10 to 35%.

7. The golf ball of claim 1, wherein the aromatic vinyl compound content in the component (11) is from 45 to 70 wt %.

8. The golf ball of claim 1, wherein the resin composition of the cover further comprises a thermoplastic polyester elastomer serving as component (III) where the content of component (III) is 30 wt % or less of the resin composition.

9. The golf ball of claim 1, wherein component (III) has a material hardness of from 20 to 50 on the Shore D hardness scale.

10. The golf ball of claim 1, wherein the rebound resilience of component (III), as measured according to JIS-K 6255 is from 50 to 80%.

11. The golf ball of claim 1, wherein component (III) has a melt viscosity at 200° C. and a shear rate of 243 sec⁻¹ which is from 0.3×10⁴ to 1.5×10⁴ dPa·s.
